(19) United States
(12) Patent Application Publication
(10) Pub. No.: US 2011/0103300 A1
(43) Pub. Date: May 5, 2011

(54) DATA ENCAPSULATION AND SERVICE DISCOVERY OVER A BROADCAST OR MULTICAST SYSTEM

(75) Inventors: Jani Petteri Vare, Kaarina (FI); Jyrki Alamaunu, Turku (FI)

(73) Assignee: NOKIA CORPORATION, Espoo (FI)

(21) Appl. No.: 12/609,600

(22) Filed: Oct. 30, 2009

(51) Int. Cl. H04W 4/00; H04B 1/66

(52) U.S. Cl. 370/328; 375/240.01

(57) ABSTRACT

Systems and methods may receive a baseband frame comprising a Layer 2 signaling section and an encapsulation protocol packet encapsulating: a service discovery real time transport protocol packet, and a real time transport protocol packet comprising at least one physical layer pipe transporting at least one service component for at least one service, wherein the Layer 2 signaling section includes a service list comprising one or more service names each associated with a respective physical layer pipe identifier of the at least one physical layer pipe; process the Layer 2 signaling section to obtain the service list; determining a desired service name of the one or more service names, the desired service name being associated with a first service component of the at least one service component; and identify a first physical layer pipe identifier associated with the desired service name to initiate decoding of the first service component.

### FIELD

Embodiments relate generally to communications networks. More specifically, embodiments relate to Open System Interconnection (OSI) Layer 1 (physical layer) (L1) and OSI Layer 2 (data link layer) (L2) information.

### BACKGROUND INFORMATION

Digital broadcast or multicast networks enable end users to receive digital content including video, audio, and data. A receiver device may receive a transport stream carrying digital content over a wireless digital broadcast network. The transport stream carries individual elements of the service such as audio, video and data components. The receiver device locates the different components of a particular program or service by processing Program Specific Information (PSI) or Service Information (SI) embedded in the transport stream.

FIG. 1 illustrates a protocol stack for second generation Digital Video Broadcasting—Terrestrial (DVB-T2) that uses Internet Protocol (IP) and User Datagram Protocol (UDP). Conventional DVB-T2 systems also require accessing, filtering, and decoding of Electronic Service Guide (ESG) data during service discovery to be able to access services.

### BRIEF SUMMARY OF EXAMPLE EMBODIMENTS

The following presents a simplified summary in order to provide a basic understanding of some aspects of the invention. The summary is not an extensive overview of the invention. It is neither intended to identify key or critical elements of the invention nor to delineate the scope of the invention. The following summary merely presents some concepts of the invention in a simplified form as a prelude to the more detailed description below.

Example embodiments may be directed to systems and methods for receiving a baseband frame comprising one or more Layer 2 signaling sections and an encapsulation protocol packet encapsulating: a service discovery real time transport protocol packet, and a real time transport protocol packet comprising at least one physical layer pipe transporting at least one service component for at least one service, wherein the one or more Layer 2 signaling sections include a service list comprising one or more service names each associated with a respective physical layer pipe identifier of the at least one physical layer pipe; processing the one or more Layer 2 signaling sections to obtain the service list; determining a desired service name of the one or more service names, the desired service name being associated with a first service component of the at least one service component; and identifying a first physical layer pipe identifier associated with the desired service name to initiate decoding of the first service component.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 illustrates a protocol stack for second generation Digital Video Broadcasting—Terrestrial.

FIG. 2 illustrates an example digital broadcast system.

FIG. 3 illustrates an example protocol stack of a broadcast system.

FIG. 4 illustrates an example of packets included in a baseband frame.

FIGS. 5-6 illustrate example relationships between a service list, an MEP packet, and an SDRTP packet transported in a baseband frame.

FIG. 7 illustrates an example syntax for the Layer 2 signaling section.

FIG. 8 illustrates an example syntax for an MEP packet.

FIG. 9 illustrates an example format of an SDRTP packet.

FIG. 10 illustrates a schematic diagram of an example head end system.

FIG. 11 illustrates a schematic diagram of an example mobile terminal.

FIG. 12 illustrates a schematic diagram of an example receiver.

FIG. 13 illustrates an example method for generating and transmitting a baseband frame.

FIG. 14 illustrates an example method for receiving and processing a baseband frame.

FIG. 15 illustrates an example method for MEP and SDRTP discovery.

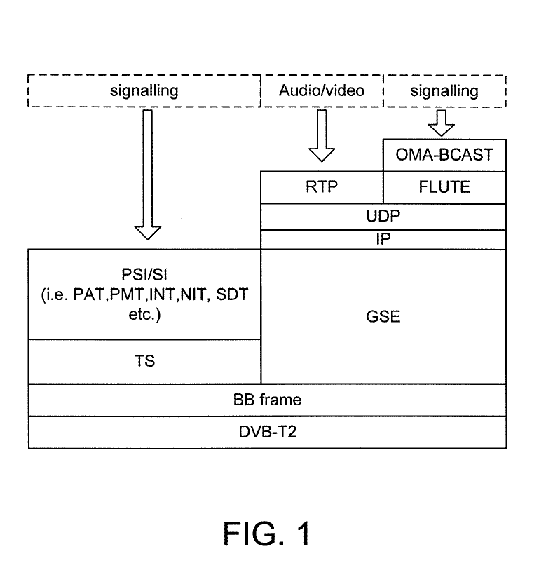

### DETAILED DESCRIPTION OF EXAMPLE EMBODIMENTS

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

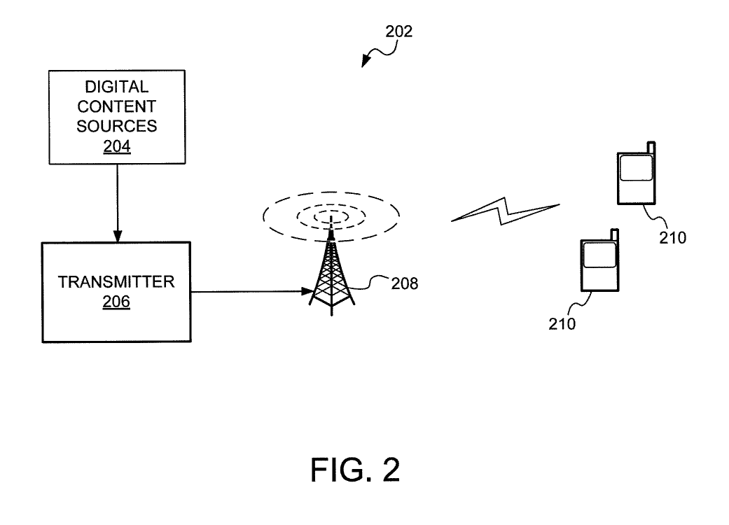

FIG. 2 illustrates an example digital broadcast system 202 in which one or more illustrative embodiments may be implemented. Systems such as the one illustrated here may utilize a digital broadcast technology, for example a multicast/broadcast system that is based on orthogonal frequency division multiplexing (OFDM), Digital Video Broadcast—Handheld (DVB-H), next generation DVB-H networks, Digital Video Broadcasting New Generation Handheld (DVB-NGH), Digital Video Broadcast Terrestrial Second Generation—Terrestrial (DVB-T2), or other DVB standards, such as DVB-MHP, DVB-Satellite (DVB-S), or DVB-Terrestrial (DVB-T). Other digital broadcast standards which may be used by the digital broadcast system 202 include Digital Video Broadcast—Terrestrial (DVB-T), Integrated Services Digital Broadcasting—Terrestrial (ISDB-T), Advanced Television Systems Committee (ATSC) Data Broadcast Standard, Digital Multimedia Broadcast-Terrestrial (DMB-T), Terrestrial Digital Multimedia Broadcasting (T-DMB), Satellite Digital Multimedia Broadcasting (S-DMB), Forward Link Only (FLO), Digital Audio Broadcasting (DAB), and Digital Radio Mondiale (DRM). Similarly, other digital transmission formats may be used to deliver content and information of availability of supplemental services, such as, NTSC (National Television System Committee), ISDB-T (Integrated Services Digital Broadcasting—Terrestrial), DMB (Digital Multimedia Broadcasting), or DIRECTV. Other digital broadcasting or multicast standards and techniques, now known or later developed, may also be used. Aspects of the invention may also be applicable to other multicarrier digital broadcast or multicast systems such as, for example, T-DAB, T/S-DMB, ISDB-T, and ATSC, proprietary systems such as Qualcomm MediaFLO/FLO, and non-traditional systems such 3GPP MBMS (Multimedia Broadcast/Multicast Services) and 3GPP2 BCMCS (Broadcast/Multicast Service).

Digital content sources 204 may provide digital services (for example, programs, channels, content, etc.) to a transmitter, which may be, for example, a head end system 206 for broadcasting to one or more mobile terminals 210. Head end system 206 may incorporate the digital services into a transport stream carrying baseband frames or baseband superframes. A baseband superframe may be composed of a predetermined number of baseband frames. The transport stream may be a data stream transporting fixed length packets. The transport stream may carry audio, video and data components of each service. The head end system 206 may forward one or more transport streams to digital broadcast tower 208 (or other physical transmission component) for wireless transmission to one or more mobile terminals 210.

The digital broadcast transmission of the baseband frames may be time sliced, such as in DVB-H technology. Time-slicing may reduce the average power consumption of the mobile terminal 210 and may enable smooth and seamless handover. Time-slicing may entail sending data in bursts using a higher instantaneous bit rate as compared to the bit rate required if the data were transmitted using a traditional streaming mechanism. The mobile terminal 210 may have one or more buffer memories for storing the decoded time sliced transmission before presentation. To reduce the amount of time required for the mobile terminal 210 to discover available services being broadcast, the head end system 206 may employ an improved protocol for the baseband frames that reduces protocol overhead.

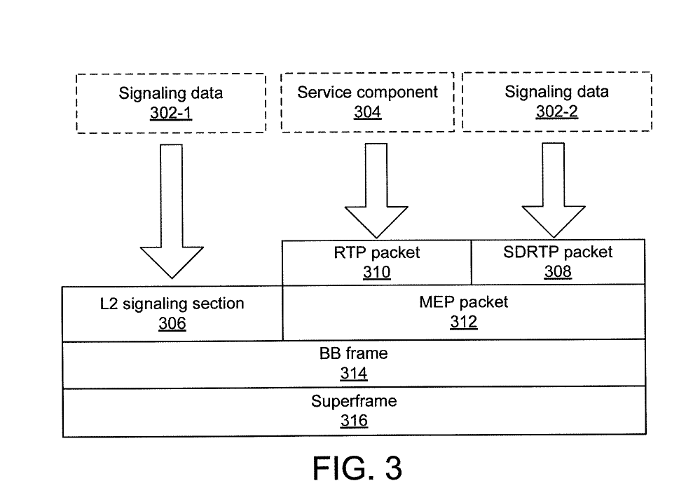

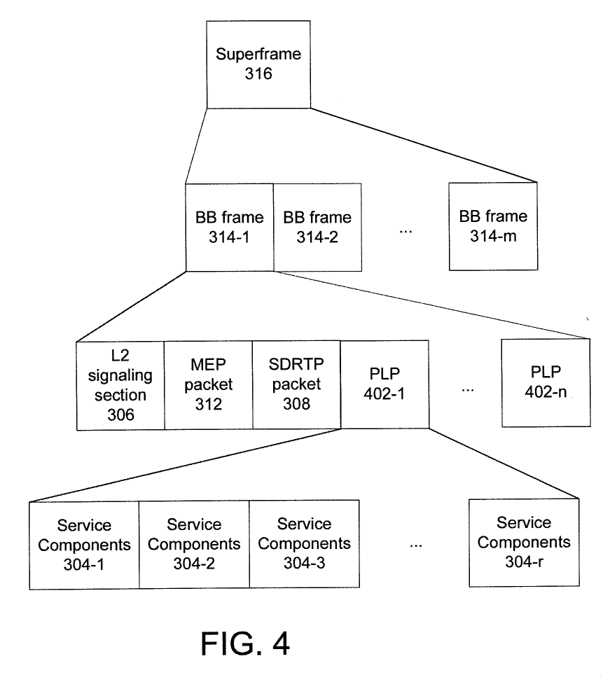

FIG. 3 illustrates an example protocol stack of a broadcast system, and FIG. 4 illustrates an example of packets included in the baseband (BB) frame 314. Generating a baseband frame 314 in accordance with the depicted protocol stack may advantageously reduce the amount of protocol overhead, as well as reducing or eliminating the amount upstream communication from the mobile terminal 210 to the digital content sources 204 during service discovery. Protocol overhead may be reduced as no Internet Protocol (IP), User Datagram Protocol (UDP) and Generic Stream Encapsulation (GSE) headers are transmitted to the mobile terminal 210 in the baseband frame 314. The information conventionally carried within IP, UDP and GSE headers is instead signaled outband in L2 and L1 signaling and is not ‘repeated’ as conventionally done in IP. Thus, L2 and L1 signaling as described herein reduces protocol overhead by not requiring IP, UDP and GSE.

The mobile terminal 210 may be configured to do service discovery without accessing and/or decoding Electronic Service Guide (ESG) metadata. Conventionally, DVB systems require accessing and decoding of the ESG prior to accessing services. The services described herein may be accessed and rendered directly due to the baseband frames 314 carrying the information for opening the service inband within the services themselves and partially outband in L2 and L1 signaling. Thus, accessing and decoding of the ESG prior to accessing services may be avoided.

The baseband frame 314 may include signaling data 302 to permit the mobile terminal 210 to discover available services and to decode their corresponding service components 304. Examples of signaling data 302 include L1 and L2 signaling information in a DVB system. The signaling data 302 includes parameters to enable the mobile terminal 210 to process received baseband frames to discover and decode available services being broadcast. The signaling data 302 may be provided within an L2 signaling section 306 and/or within a service discovery real-time transport protocol (SDRTP) packet 308.

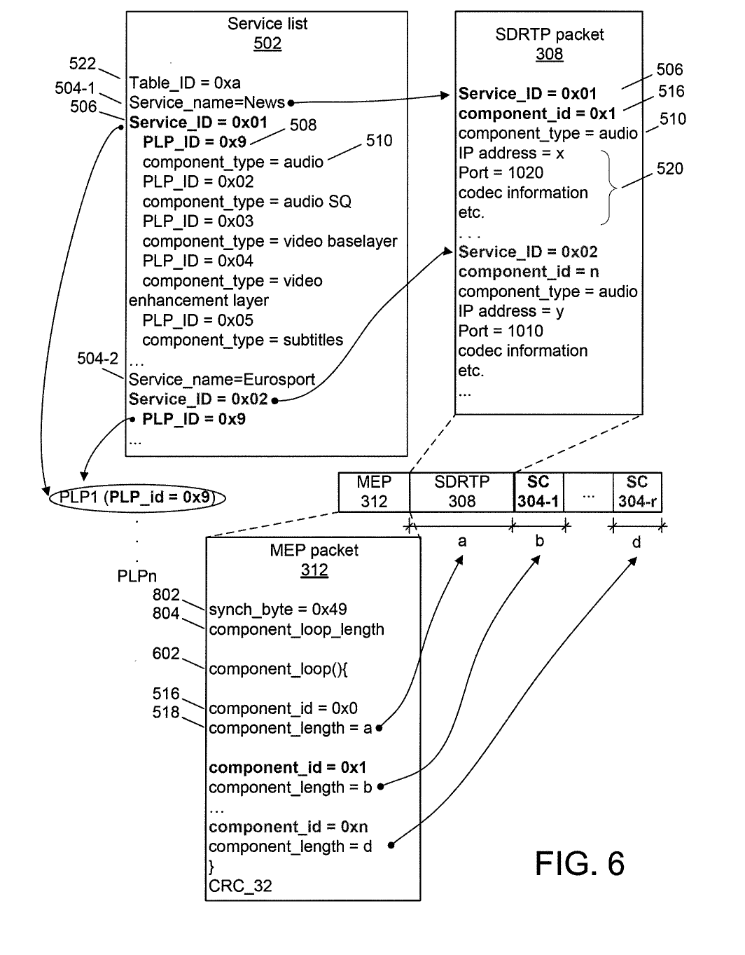

The signaling data 302 may contain similar data to that carried in Open Mobile Alliance Broadcast (OMA-BCAST) signaling. FIG. 6 illustrates an example of the mapping of the signaling data parameters and their relation. Examples of the OMA-BCAST specific parameters may be an IP address, port, codec information etc.

Service components 304 may be encapsulated into one or more real-time transport protocol (RTP) packets 310, such as RTP packets in accordance with Request for comment (RFC) 3550, titled “RTP: A Transport Protocol for Real-Time Applications,” July 2003, the contents of which are hereby incorporated by reference in their entirety. Examples of service components 304 include video components (for example, base layer and enhancement layer for scalable video coding (SVC)), audio components, data components, subtitles, and any further data or metadata.

The RTP packets 310 and SDRTP packets 308, but not the L2 signaling section 306, are further encapsulated within Minimal Encapsulation Protocol (MEP) packets 312. MEP is minimal due to carrying only the minimum information needed by the mobile terminal 210 to decapsulate RTP streams from MEP packets 312. The L2 signaling section 306 may be carried in a dedicated physical layer pipe (PLP) 402 and identified by a table identifier table_id 522, discussed below, and hence do not need to be encapsulated with MEP. The L2 signaling section 306 and the MEP packets 312 are then encapsulated in one or more baseband frames 314.

The service components 304 for a particular broadcast or multicast service may be assigned to one or more physical layer pipes (PLP) 402 within the MEP packet 312. This assignment may be done by a network head-end, multiplexer, IP encapsulator, or similar equipment. A PLP 402 may be a physical layer TDM channel that is carried by one or more time subslices of the baseband frame 314. FIG. 4, for example, illustrates PLP 402-1 of MEP packet 312 transporting service components 304-1 to 304-r.

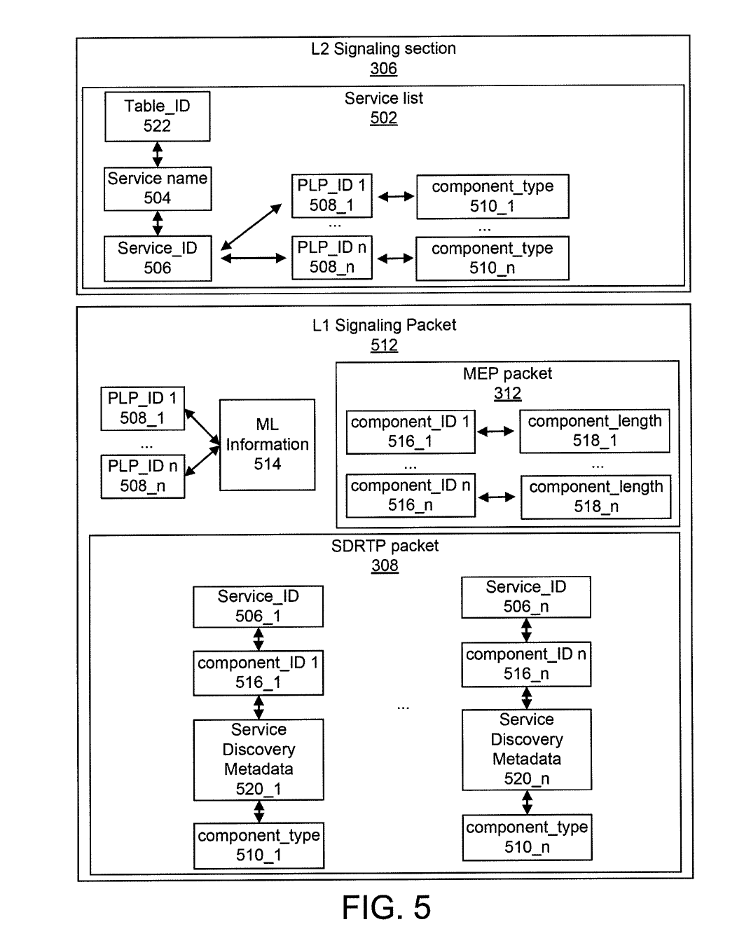

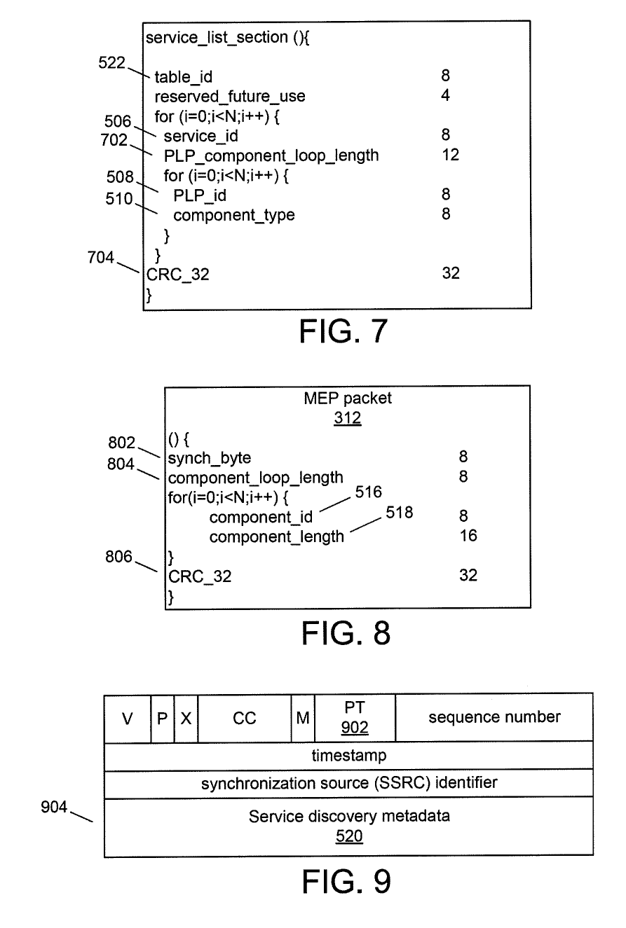

FIGS. 5-6 illustrate example relationships between a service list 502, the MEP packet 312, and the SDRTP packet 308 carried in the baseband frame 314, and FIGS. 7-9 illustrate example syntax/data structures used by the mobile terminal 210 to discover and decode available services. The service list 502 may indicate which services are being broadcast in the baseband frame 314, the MEP packet 312 may indicate a location of service components 304 associated with each service, and the SDRTP packet 308 may provide information for decoding service components 304 of interest within the MEP packet 312.

Initially, the mobile terminal 210 may present the available services listed in the service list 502 for user selection. The mobile terminal 210 may then identify a MEP packet 312 transporting service components 304 associated with a selected service. The mobile terminal 210 may then process the SDRTP packet 308 contained in the MEP packet 312 to extract information for decoding the service components 304 associated with the selected service.

With reference to FIG. 5, the L2 signaling section 306 may include a service list 502 identifying available services (for example, a news channel, a sports program, an entertainment channel) being broadcast within the superframe 316. The superframe 316 may include multiple service lists 502 each associated with a table identifier table_id 522. The table_id 522 is a unique code identifying a particular service list 502 within the superframe 316.

The service list 502 may specify a service name 504 for each available service being broadcast. The service name 504 may be information presented to aide a user in selecting a service of interest. A service name 504 may be, for example, ‘News’ for a news service/channel, ‘Sports’ for a sports channel, etc. Each service name 504 may have an associated service_id 506 that is a unique identifier for the service. The service_id 506 is associated with one or more physical layer pipe identifiers PLP_id 508_1 to 508_{—}n uniquely identifying the respective PLPs 402-1 to 402-n within a baseband frame 314 that transport service components 304 of a particular service. For example, in FIG. 4, the ‘News’ service may be transported by PLP 402-1 carrying an audio service component 304-1, a video service component 304-2, and a data service component 304-3.

In FIG. 5, each PLP_id 508 may be associated with a component type 510. The component type 510 may indicate a type (for example, audio, audio SQ, video, video base layer, data, subtitles or any further data or metadata) of a particular service component 304. In an example, the value of the type may be the same as have been defined for the component descriptor in ETSI EN 300 468 V1.5.1 (2003-05) titled “Digital Video Broadcasting (DVB); Specification for Service Information (SI) in DVB system,” the contents of which are hereby incorporated by reference in their entirety. Other types for the service components 304 may also be used.

FIG. 7 depicts an example syntax for a L2 signaling section of a service list 502. The mobile terminal 210 may search the superframe 316 for a table_id 522 having a particular value. Once found, the mobile terminal 210 may identify ‘N’ service_ids 506 included in the service list 502. The mobile terminal 210 may then process a PLP component loop length 702 that indicates a length (for example, in bytes) of the PLP 402 and of a component loop immediately following the PLP component loop length 702 field. The mobile terminal 210 may then identify each PLP_id 508 and component type 510 associated with each service_id 506. Once all have been identified, the mobile terminal 210 may process a cyclic redundancy check (CRC) field 704. The CRC field 704 may contain a CRC value (for example, 32 bit value) for the service list 502 to confirm that there are no errors in the service list 502.

In FIG. 6, for example, a service list 502 lists “News” as a first service name 504-1 and “Eurosport” as a second service name 504-2. The News service name 504-1 is associated with service_ID=0×01, which is associated with PLP_ID=0×9 for audio, PLP_ID=0×02 for stereo quadraphonic (SQ) audio, PLP_ID=0×03 for video baselayer, PLP_ID=0×04 for video enhancement layer, and PLP_ID=0×05 for subtitles. The mobile terminal 210 may search the baseband frame 314 for PLP ids=0×9, 0×02, 0×03, 0×04, and 0×05 in response to a user selecting the “News” service name 504. The PLP_ids 508 identify MEP packets 312 transporting the service components 304 of the selected service.

Referring again to FIG. 5, an L1 signaling packet 512 may associate the PLP_ids 508_1 to 508_{—}n associated with a particular service_id 506 to locations of one or more MEP packets 312 within superframe 316. The MEP packet location (ML) information 514 identifies a location of a MEP packet 312 within superframe 316 corresponding to a particular PLP_id 508.

The MEP packet encapsulates service components of a particular PLP. In FIG. 4, for example, MEP packet 312 encapsulates PLP 402-1 and its service components 304-1 to 304-r.

In FIGS. 5-6 and 8, the MEP packet 312 provides information on the location of each service component 304 within the MEP packet 312. In FIG. 5, the MEP packet 312 associates each component_id 516 with a component length 518. The component_id 516 may be a fixed length field (for example, 8-bits) including a unique identifier of a particular service component 304. A component length 518 may be a fixed length field (for example, 16-bits) indicating a length (for example, in bytes) of a service component 304. In FIG. 6, for example, component_id=0×1 may uniquely identify service component 304-1 having a component length of ‘b.’

In FIG. 6, the MEP packet 312 lists the component_ids 516 and component lengths 518 in the same order as service components (SC) 304-1 to 304-r appear in the MEP packet 312 after the SDRTP packet 308. By analyzing the lengths of any preceding service component, the mobile terminal 210 may identify the starting location of a service component of interest. In FIG. 6, for example, the MEP packet 312 lists component_ids 0×1 to 0×n, wherein component_id=0×0 has a component_length of ‘a’ bytes, component_id=0×1 has a component_length of ‘b’ bytes, and component_id=0×n has a component_length of ‘d.’ bytes.

FIG. 8 illustrates an example syntax for identifying a MEP packet 312 within a baseband frame 314. The mobile terminal 210 may detect a synch byte 802 to determine a beginning of the MEP packet 312. A value of the synch byte 802 may be set to a fixed value (for example, 0×49). A component loop length 804 may be a fixed length field (for example, 8-bits) indicating a length of an ensuing component loop 602 to determine the end of the MEP packet 312. The mobile terminal 210 may then identify each component_id 516 and associated component length 518 for the service components 304 encapsulated within the MEP packet 312. The mobile terminal 210 may process a CRC field 806. The CRC field 806 may be a fixed length field (for example, 32-Bits) containing a cyclic redundancy check (CRC) value for the MEP packet 312.

In FIG. 6, the SDRTP packet 308 may be transported in the first service component 304 of the MEP packet 312. The SDRTP packet 308 provides information to enable the mobile terminal 210 to decode service components 304 contained within the MEP packet 312. To identify a beginning of the SDRTP packet 308, the mobile terminal 210 may search the MEP packet 312 for a component_id 516 having a predetermined value (for example, 0×0). The SDRTP packet 308 provides information for the mobile terminal 210 to decode and display the desired components, such as, but not limited to, service discovery metadata 520 (for example, codec information, an IP address, and a port). The SDRTP packet 308 relates each service_id 506 with a component_id 516, service discovery metadata 520, and a component type 510. The SDRTP packet 308 in FIG. 6 corresponding to the “News” service name, for example, associates service_id=0×01, component_id=0×1, component_type=audio, and service discovery metadata 520 specifying IP address=x, Port=1020, and codec information.

FIG. 9 illustrates an example format of the SDRTP packet 308. SDRTP is special type of RTP. The RTP protocol permits definition of different payload types and hence ‘RTP’-like packets meant for different purposes. During service discovery, the mobile terminal 210 may process a payload type (PT) field 902 to determine when a payload 904 of the SDRTP packet 308 includes service discovery metadata 520. The metadata 520 may be structured, for example, in eXtensible Markup Language (XML) syntax. The service discovery metadata 520 may associate the service_id 506, a component_id 516, an IP address, a port, and codec information. The remaining fields in the SDRTP packet 308 of FIG. 9 may be defined in accordance with RFC 3550 or other RTP protocols.

The mobile terminal 210 may use the information carried in the SDRTP packet 308 to re-construct UDP and IP packets to enable a distribution of the service and/or service components to other modules via a specific protocol. The mobile terminal 210 may re-construct headers for UDP/IP packets and hence function as an encapsulator to transmit the data onward with the UDP/IP protocol. The re-construction is possible due to the parameters signaled and assigned to particular services within the SDRTP packet 308.

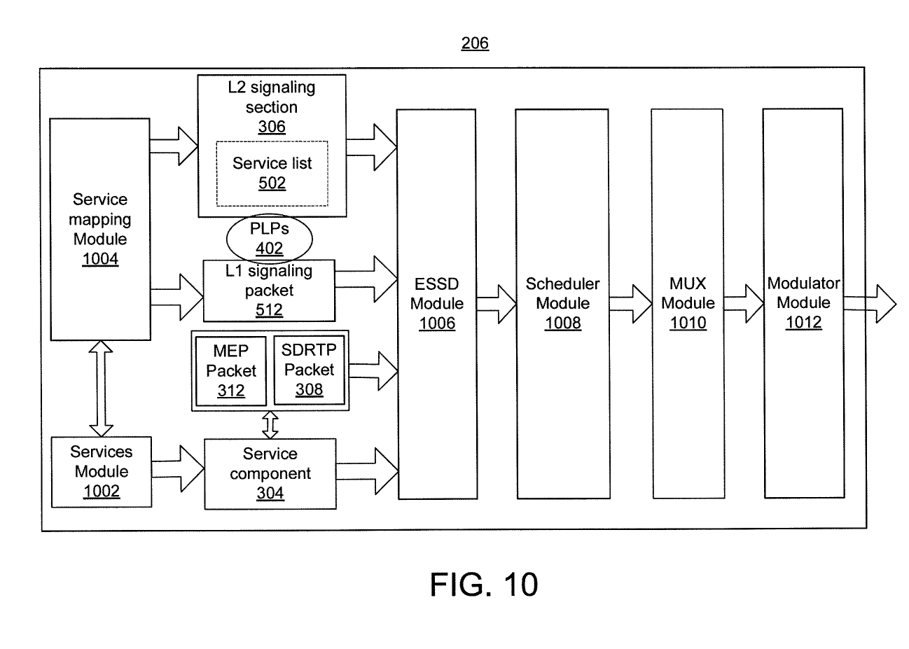

FIG. 10 illustrates a schematic diagram of an example apparatus which may be, for example, a transmitter or head end system 206 for generating baseband frames 314. The head end system 206 may include multiple modules for performing functions. A module may be embodied as hardware, firmware, software, and/or any combination thereof. In an example, a module may include at least one or more memories storing software that includes computer executable instructions and the head end system 206, as well as the digital broadcast receiver 141 described below, may include at least one or more processors to execute the software. The memory may be implemented with any combination of read only memory modules or random access memory modules, optionally including both volatile and nonvolatile memory. Also, a module may include its own processor and memory.

A services module 1002 may receive one or more services from a digital content source 204 and split the services into one or more service components 304. A service mapping module 1004 may perform preliminary scheduling to create the L1 signaling packet 512 and the L2 signaling section 306, which includes the service list 502, for the services and service components and to allocate time slices in the baseband frame 314 to one or more PLPs 402.

An encapsulation of Signaling and Service Data (ESSG) module 1006 may encapsulate the service components 304 in RTP to form one or more RTP packets 310. The ESSG module 1006 may then encapsulate the RTP packets 310 and the SDRTP packet 308 using the minimal encapsulation protocol (MEP) to form the MEP packets 312. The ESSG module 1006 then may encapsulate the L2 signaling section 306 and the MEP packet 312 to form a baseband frame 314. A scheduler module 1008 may then schedule one or more baseband frames 314 for transmission. A MUltipexor (MUX) module 1010 may multiplex the baseband frames 314 to form a superframe 316 and a modulator module 1012 may cause transmission of a digital broadcast transmission signal carrying the superframe 316 to the mobile terminal 210.

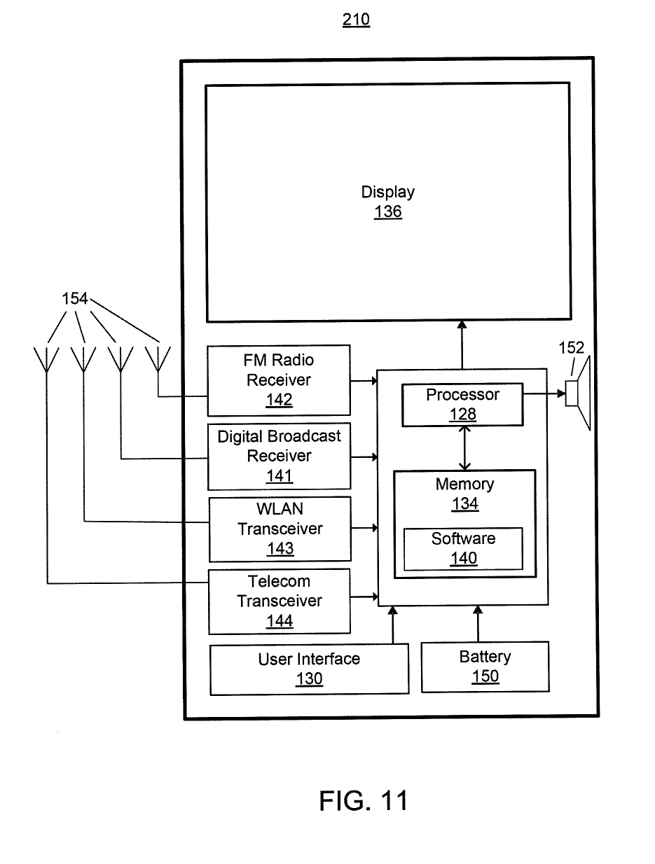

FIG. 11 illustrates an example schematic diagram of an apparatus which may be, for example, a mobile terminal 210 for receiving and processing digital transmissions. The mobile terminal 210 may be a cellular phone, a laptop, a PDA, a set top box, a television set, or other device configured for communication via a data network. The mobile terminal 210 may include processor 128 connected to user interface 130, memory 134 and/or other storage, and display 136, which may be used for displaying video content, service names of available services, and the like to a user. Mobile terminal 210 may also include battery 150, audio speaker 152 and antennas 154. User interface 130 may further include a keypad, touch screen, voice interface, one or more arrow keys, joy-stick, data glove, mouse, roller ball, touch screen, or the like. In some embodiments the apparatus may contain one or more processors and/or one or more memories.

Computer executable instructions and data used by processor 128 and other components within mobile terminal 210 may be stored in a computer readable memory 134. The memory may be implemented with any combination of read only memory modules or random access memory modules, optionally including both volatile and nonvolatile memory. Software 140 may be stored within memory 134 and/or storage to provide instructions to processor for enabling mobile terminal 210 to perform various functions. Some or all of mobile terminal 210 computer executable instructions may be embodied in hardware or firmware.

A digital broadcast receiver 141 of the mobile terminal 210 may be configured to receive, decode and process digital broadcast transmissions that are based, for example, on a digital video broadcast standard, such as DVB-H, DVB-T, or the like. The mobile terminal 210 may also be provided with other types of receivers for digital broadcast transmissions. Additionally, mobile terminal 210 may also be configured to receive, decode and process transmissions through FM/AM Radio receiver 142, WLAN transceiver 143, and telecommunications transceiver 144.

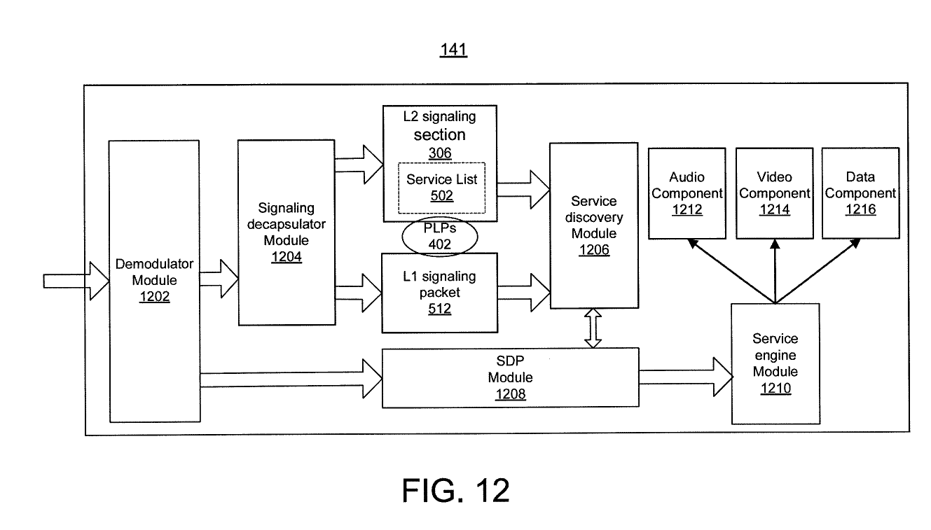

FIG. 12 illustrates a schematic diagram of an example receiver apparatus which may be, for example, a digital broadcast receiver 141. A demodulator module 1202 is configured to receive digital broadcast transmissions, such as, but not limited to, a wireless radio frequency (RF) signal carrying the baseband frame 314, inspect preamble information, and to output demodulated signals to the signaling decapsulator module 1204 and the service decapsulation and processing (SDP) module 1208. The signaling decapsulator module 1204 may decapsulate the L2 signaling section 306 and the L1 signaling packet 512 from the baseband frame 314. The service discovery module 1206 processes L2 signaling section 306 and the L1 signaling packet 512 and exchanges information with the SDP module 1208 to decapsulate the service components 304. The SDP module 1208 then sends the decapsulated service component 304 to a service engine module 1210. The service engine module 1210 outputs at least one of an audio component 1212, a video component 1214, and a data component 1216 for rendering on the display 136 and/or via the audio speaker 152.

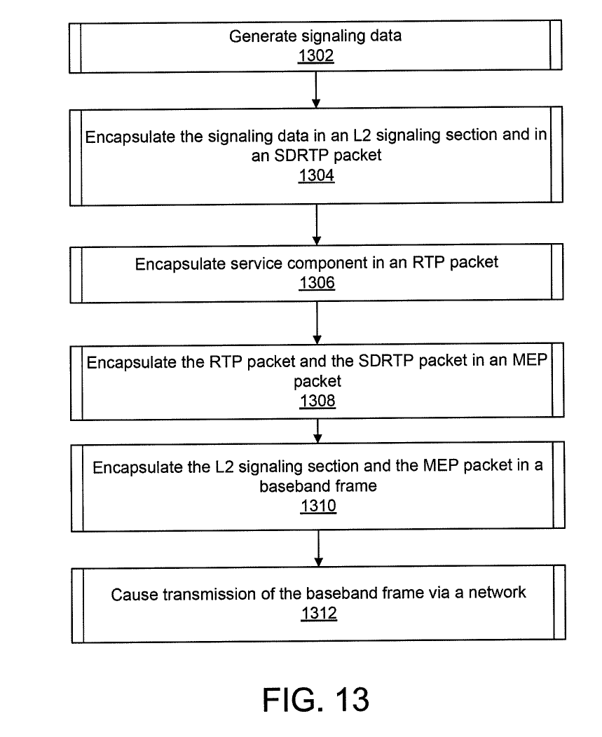

FIG. 13 illustrates an example method for generating and transmitting a baseband frame 314. The method steps may be performed by the structures shown in FIG. 10. The method may begin at block 1302.

In block 1302, the method may include generating signaling data 302.

In block 1304, the method may include encapsulating the signaling data 302 in a L2 signaling section 306 and in an SDRTP packet 308.

In block 1306, the method may include encapsulating one or more service components 304 in one or more RTP packets 310.

In block 1308, the method may include encapsulating the RTP packet 310 and the SDRTP packet 308 in an MEP packet 312.

In block 1310, the method may include encapsulating the L2 signaling section 306 and the MEP packet 312 in a baseband frame 314.

In block 1312, the method may include causing transmission of the baseband frame 314 via a network. The method may then end.

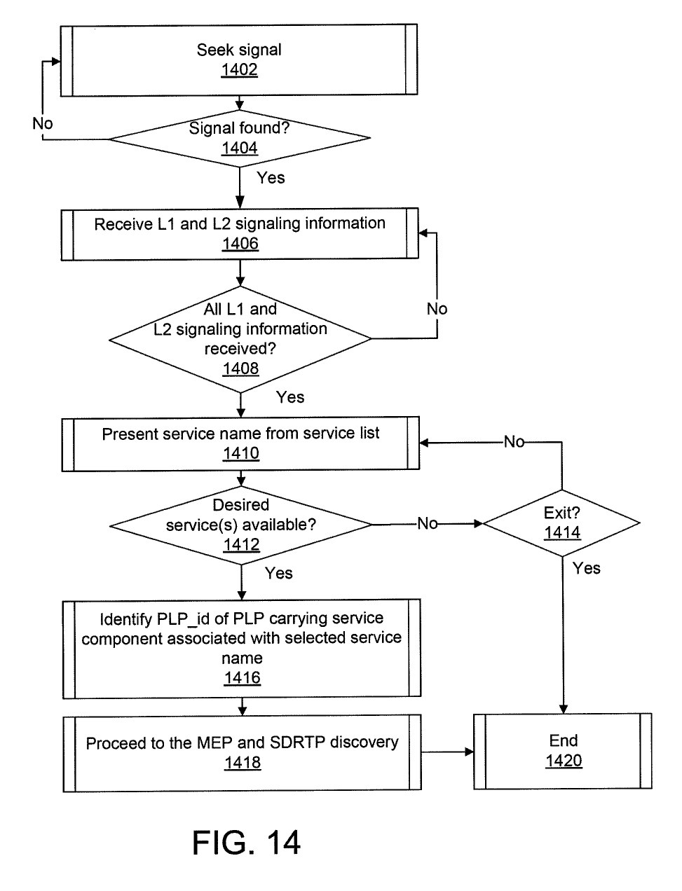

FIG. 14 illustrates an example method for receiving and processing a baseband frame.

These steps may be performed by the structures shown in FIG. 12. The method may begin at block 1402.

In block 1402, the method may include seeking for a signal. In an example embodiment, the signal may be a radio frequency signal carrying baseband frames 314. The baseband frame 314 may include a plurality of physical layer pipes 402 transporting a plurality of service components 304 for a plurality of services.

In block 1404, the method may include determining whether the signal has been found. If not found, the method may return to block 1402 to continue seeking for the signal. If found, the method may continue to block 1406.

In block 1406, the method may include processing the signal to identify a baseband frame 314 including L1 and L2 signaling information. For example, the mobile terminal 210 may process the signal to identify header synchronization information in the baseband frame 314 process the baseband frames 314 to identify the L2 signaling section 306 and the SDRTP packet 308. The L2 signaling section 306 may include a service list 502 comprising a plurality of service names 504 each associated with a respective physical layer pipe identifier 508 of the plurality of physical layer pipes 402. The L1 signaling information may be carried within an L1 signaling packet 512 of the baseband frame 314.

In block 1408, the method may include determining whether all of the L1 and L2 signaling information has been received. For example, the L1 signaling packet 512 and the L2 signaling section 306 may indicate how much L1 and L2 signaling information there is to permit the mobile terminal 210 to determine whether all of the L1 and L2 signaling information has been received. If not all has been received, the method may return to block 1406; otherwise, the method may continue to block 1410.

In block 1410, the method may include presenting service names 504 from the service list 502 for user selection. The service names 504 may be defined, for example, by a content provider or a mobile operator.

In block 1412, the method may include determining whether the desired service that may be selected by a user is available. In an example embodiment, the mobile terminal 210 may present to the user at display 136 the service names 504 of each service available on the service list 502. If a desired service is not available, the method may continue to block 1414, and if available, the method may continue to block 1416.

In block 1414, the method may include prompting a user whether to exit service discovery. In an example embodiment, the mobile terminal 210 may prompt to the user via display 136 to exit service discovery and the user may supply user input. If the user input indicates a desire by the user to exit service discovery, the method may proceed to block 1420 and end. If the user input indicates a desire not to exit, the method may return to block 1410.

In block 1416, the method may include identifying a PLP_id 508 of a PLP 402 carrying a service component 304 associated with the selected service name 504 to initiate decoding of the service component 304.

In block 1418, the method may include proceeding to MEP and SDRTP discovery for decoding of the encapsulated service component 304. For example, the mobile terminal 210 may initiate accessing and decoding of the MEP packet 312 and the SDRTP packet 308. The method may then proceed to block 1420 and end.

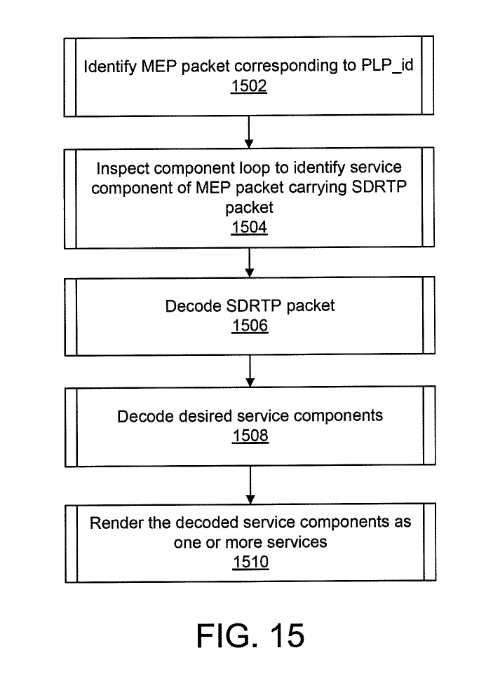

FIG. 15 illustrates an example method for MEP and SDRTP discovery. The method may begin at block 1502.

In block 1502, the method may include identifying the MEP packet 312 corresponding to the PLP_id 508 associated with a selected service name 504.

In block 1504, the method may include inspecting component loop length 702 to identify the service component 304 of the MEP packet 312 carrying the SDRTP packet 308.

In block 1506, the method may include decoding the service component 304 carrying the SDRTP packet 308 to identify the service discovery metadata 520 for decoding the service components 304 of the service associated with the selected service name 504.

In block 1508, the method may include decoding the service components 304. For example, the mobile terminal 210 may identify the service components 304 based on their location within the baseband frame 314 specified in the MEP packet 312. The mobile terminal 210 may then apply the service discovery metadata 520 to determine how to decode the service components 304 of the desired service.

In block 1510, the method may include rendering the decoded service components 304 as one or more services. The method may then end.

One or more aspects of the above examples may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), application specific integrated circuits (ASIC), and the like.

While embodiments have been described with respect to specific examples including presently preferred modes of carrying out the invention, those skilled in the art will appreciate that there are numerous variations and permutations of the above described systems and techniques. Thus, the spirit and scope of the invention should be construed broadly as set forth in the appended claims.

We claim:

1. A method comprising:
receiving a baseband frame comprising a Layer 2 signaling section and an encapsulation protocol packet encapsulating:
a service discovery real time transport protocol packet, and
a real time transport protocol packet comprising at least one physical layer pipe transporting at least one service component for at least one service;
wherein the Layer 2 signaling section includes a service list comprising one or more service names each associated with a respective physical layer pipe identifier of the at least one physical layer pipe;
processing the Layer 2 signaling section to obtain the service list;
determining a desired service name of the one or more service names, the desired service name being associated with a first service component of the at least one service component; and
identifying a first physical layer pipe identifier associated with the desired service name to initiate decoding of the first service component.

2. The method of claim 1, further comprising identifying a location of the encapsulation protocol packet within the baseband frame using the first physical layer pipe identifier.

3. The method of claim 2, further comprising processing the encapsulation protocol packet to identify a location of the service discovery real time transport protocol packet.

4. The method of claim 3, further comprising processing the service discovery real time transport protocol packet to obtain service discovery metadata corresponding to the first service component.

5. The method of claim 4, further comprising decoding the first service component using the service discovery metadata to generate a decoded service component.

6. The method of claim 5, further comprising causing rendering of the decoded service component.

7. The method of claim 1, wherein the determining of the desired service name of the one or more service names comprises:
causing presentation of the one or more service names from the service list; and
receiving an input selecting the desired service name.

8. An apparatus comprising:
at least one processor; and
at least one memory storing computer executable instructions that, when executed, cause the apparatus to:
receive a baseband frame comprising a Layer 2 signaling section and an encapsulation protocol packet encapsulating:
a service discovery real time transport protocol packet, and
a real time transport protocol packet comprising at least one physical layer pipe transporting at least one service component for at least one service;
wherein the Layer 2 signaling section includes a service list comprising one or more service names each associated with a respective physical layer pipe identifier of the at least one physical layer pipe;
process the Layer 2 signaling section to obtain the service list;
determine a desired service name of the one or more service names, the desired service name being associated with a first service component of the at least one service component; and
identify a first physical layer pipe identifier associated with the desired service name to initiate decoding of the first service component.

9. The apparatus of claim 8, wherein the computer executable instructions, when executed, cause the apparatus to identify a location of the encapsulation protocol packet within the baseband frame using the first physical layer pipe identifier.

10. The apparatus of claim 9, wherein the computer executable instructions, when executed, cause the apparatus to process the encapsulation protocol packet to identify a location of the service discovery real time transport protocol packet.

11. The apparatus of claim 10, wherein the computer executable instructions, when executed, cause the apparatus to process the service discovery real time transport protocol packet to obtain service discovery metadata corresponding to the first service component.

12. The apparatus of claim 11, wherein the computer executable instructions, when executed, cause the apparatus to decode the first service component using the service discovery metadata to generate a decoded service component.

13. The apparatus of claim 12, wherein the computer executable instructions, when executed, cause the apparatus to cause rendering of the decoded service component.

14. One or more computer readable media storing computer executable instructions that, when executed, cause a processor to perform a method comprising:
receiving a baseband frame comprising a Layer 2 signaling section and an encapsulation protocol packet encapsulating:
a service discovery real time transport protocol packet, and
a real time transport protocol packet comprising at least one physical layer pipe transporting at least one service component for at least one service;
wherein the Layer 2 signaling section includes a service list comprising one or more service names each associated with a respective physical layer pipe identifier of the at least one physical layer pipe;
processing the Layer 2 signaling section to obtain the service list;
determining a desired service name of the one or more service names, the desired service name being associated with a first service component of the at least one service component; and
identifying a first physical layer pipe identifier associated with the desired service name to initiate decoding of the first service component.

15. A method comprising:
generating signaling information;
encapsulating the signaling information in a Layer 2 signaling section and in a service discovery real time transport protocol packet;
encapsulating a service component of a service in a real time transport protocol packet;
encapsulating the real time transport protocol packet and the service discovery real time transport protocol packet in an encapsulation packet;
encapsulating the Layer 2 signaling section and the encapsulation packet in a baseband frame; and
causing transmission of the baseband frame.

16. The method of claim 15, further comprising allocating a physical layer pipe in the baseband frame for transporting the service component.

17. The method of claim 15, wherein the generating of the signaling data further comprises creating a service list associating at least one or more services to service names.

18. An apparatus comprising:
at least one processor; and
at least one memory storing computer executable instructions that, when executed, cause the apparatus to perform:
generating signaling information;
encapsulating the signaling information in a Layer 2 signaling section and in a service discovery real time transport protocol packet;
encapsulating a service component of a service in a real time transport protocol packet;
encapsulating the real time transport protocol packet and the service discovery real time transport protocol packet in an encapsulation protocol packet;
encapsulating the Layer 2 signaling section and the encapsulation protocol packet in a baseband frame; an
causing transmission of the baseband frame.

19. The apparatus of claim 18, wherein the computer executable instructions, when executed, cause the apparatus to allocate a physical layer pipe in the baseband frame for transporting the service component.

20. The apparatus of claim 18, wherein the computer executable instructions, when executed, cause the apparatus to create a service list associating at least one or more services to service names.

21. An apparatus comprising:
means for generating signaling information;
means for encapsulating the signaling information in a Layer 2 signaling section and in a service discovery real time transport protocol packet;
means for encapsulating a service component of a service in a real time transport protocol packet;
means for encapsulating the real time transport protocol packet and the service discovery real time transport protocol packet in an encapsulation protocol packet;
means for encapsulating the Layer 2 signaling section and the encapsulation protocol packet in a baseband frame; an
means for causing transmission of the baseband frame.
